(19) United States
(12) Patent Application Publication
(10) Pub. No.: US 2024/0092248 A1
(43) Pub. Date: Mar. 21, 2024

(54) VEHICLE LIGHTING DEVICE

(71) Applicant: HONDA MOTOR CO., LTD., Tokyo (JP)

(72) Inventors: Masayoshi TAKORI, Saitama (JP); Yuji TSUCHIYA, Saitama (JP)

(21) Appl. No.: 18/465,171

(22) Filed: Sep. 12, 2023

(30) Foreign Application Priority Data
Sep. 14, 2022 (JP) 2022-146512

(51) Int. Cl. B60Q 1/14

(52) U.S. Cl. CPC B60Q 1/1415; B60Q 2300/054

(57) ABSTRACT

A vehicle lighting device includes: a low-beam irradiation part which illuminates a lower irradiation region on a forward lower side of a vehicle; a high-beam irradiation part which illuminates an upper irradiation region on an upper side and more to a central side in a vehicle-width direction than the lower irradiation region; and a pattern irradiation part which irradiates irradiation light on a lateral irradiation region that is a travel path side of the vehicle in an irradiation pattern in which a bright region and a dark region are alternately repeated, in which the pattern irradiation part irradiates irradiation light in a predetermined first mode on an upper pattern irradiation region that is an upper side of the lateral irradiation region, and irradiates irradiation light in a second mode different from the first mode in a lower pattern irradiation region that is a lower side of the lateral irradiation region.

This application is based on and claims the benefit of priority from Japanese Patent Application No. 2022-146512, filed on 14 Sep. 2022, the content of which is incorporated herein by reference.

### BACKGROUND OF THE INVENTION

### Field of the Invention

The present invention relates to a vehicle lighting device.

### Related Art

As a vehicle lighting device, a device has been proposed which suppresses dazzling of pedestrians, while enabling the driver to favorably visually recognize pedestrians (for example, refer to Patent Document 1). With the vehicle lighting device of Patent Document 1, the illumination amount to the upper body of the pedestrian is reduced (set to zero) according to the distance to the pedestrian acquired by a pedestrian detection sensor.

Patent Document 1: Japanese Unexamined Patent Application, Publication No. 2013-184614

### SUMMARY OF THE INVENTION

However, there is a trend of the accidents due to overlooking pedestrians in front of the vehicle increasing on straight roads. It must be ensured that such overlooking of pedestrians does not occur. In Patent Document 1, when emphasizing the suppression of dazzling on the side of pedestrians, there is concern over the characteristic for pedestrian visual recognition on the side of the driver being diminished.

The present invention has been made taking account of the aforementioned situation, and has an object of providing a vehicle lighting device which suppress dazzling on the side of pedestrians, while raising no concern over the characteristic for pedestrian visual recognition on the side of the driver being diminished. In addition, it consequently has an object of contributing to the development of sustainable transportation systems which further improve traffic safety.

A vehicle lighting device according to a first aspect of the present invention includes: a low-beam irradiation part (for example, the low-beam unit 7 described later) which illuminates a lower irradiation region (for example, the low-beam irradiation region 11 described later) on a forward lower side of a vehicle (for example, the vehicle 2 described later); a high-beam irradiation part (for example, the high-beam unit 6 described later) which illuminates an upper irradiation region (for example, the high-beam irradiation region 10 described later) on an upper side and more to a central side in a vehicle-width direction than the lower irradiation region; and a pattern irradiation part (for example, the projector unit 8 described later) which irradiates irradiation light on a lateral irradiation region (for example, the right-side pattern irradiation region 12 described later) that is a travel path side of the vehicle in an irradiation pattern (for example, the first irradiation pattern 15 described later) in which a bright region (for example, the bright region 13 described later) and a dark region (for example, the dark region 14 described later) are alternately repeated, in which the pattern irradiation part irradiates irradiation light in a predetermined first mode on an upper pattern irradiation region (for example, the upper pattern irradiation region 17 described later) that is an upper side of the lateral irradiation region, and irradiates irradiation light in a second mode different from the first mode in a lower pattern irradiation region (for example, the lower pattern irradiation region 18 described later) that is a lower side of the lateral irradiation region.

According to a second aspect of the present invention, in the vehicle lighting device as described in the first aspect, the second mode is higher irradiation intensity than the first mode.

According to a third aspect of the present invention, in the vehicle lighting device as described in the first or second aspect, the first mode is a mode which irradiates irradiation light in an irradiation pattern (for example, the first irradiation pattern 15 described later) which is a rhombus lattice pattern by bright regions (for example, the bright region 13 described later) of a mesh design of rhombus lattice, and dark regions (for example, the dark region 14 described later) surrounded by the bright regions, and the second mode is a mode which irradiates irradiation light in a lattice-like irradiation pattern (for example, the second irradiation pattern 20 described later) in which vertical and horizontal lattice-like bright regions are superimposed on dark regions serving as a background.

With the vehicle lighting device of the first aspect, it is possible to easily recognize the presence of pedestrians on the roadside from the side of the driver by the visual characteristic of humans, while the illumination by the irradiation light in the first mode that irradiates the upper pattern irradiation region of the lateral irradiation region of the pattern irradiation part is suppressed to avoid dazzling on the side of the pedestrian. On the other hand, irradiation light in the second mode different from the first mode is irradiated on the lower pattern irradiation region of the lateral irradiation region; however, it is possible make the irradiation light in the second mode in a mode whereby the presence of pedestrians on the roadside easily recognizable. In addition, it consequently leads to further improvement in traffic safety and contribute to development of a sustainable transportation system.

With the vehicle lighting device of the second aspect, since the irradiation intensity of irradiation light is relatively high in the second mode on the lower pattern irradiation region, the irradiation light in the second mode can irradiate the legs of pedestrians on the roadside with high illumination, and motion of the legs of a pedestrian can be remarkably recognized from the side of the driver. On the other hand, since the irradiation region of irradiation light is relatively low in the first mode on the upper pattern irradiation region, it is possible to avoid dazzling on the side of pedestrians.

With the vehicle lighting device of the third aspect, when light of the first irradiation pattern which is a rhombus lattice pattern is irradiated on a pedestrian, the driver can recognize the presence of pedestrians easily.

### BRIEF DESCRIPTION OF THE DRAWINGS

FIG. 1 is a schematic view showing an aspect of irradiation of illumination light by a vehicle lighting device according to an embodiment of the present invention;

FIG. 2 is a block diagram of the vehicle lighting device according to an embodiment of the present invention;

FIG. 3 is a view showing an irradiation region of each lamp in the vehicle lighting device in FIG. 2;

FIG. 4 is a view showing an irradiation region of a lamp in the case of the vehicle lighting device in FIG. 2 operating in low-beam mode;

FIG. 5 is a view showing an example of an irradiation pattern by a pattern irradiation part of the vehicle lighting device in FIG. 2;

FIG. 6 is a view showing an aspect of a driver field of view at night irradiated by the vehicle lighting device of FIG. 2; and

FIG. 7 is a view showing another example of an irradiation pattern by the pattern irradiation part in the vehicle lighting device of FIG. 2.

### DETAILED DESCRIPTION OF THE INVENTION

Hereinafter, an embodiment of the present invention will be explained while referencing the drawings. It should be noted that, in the following explanation, irradiation region is the irradiation area of light by the lamp, and irradiation pattern is a design by a bright region and dark region of the irradiation region, contour shape of the irradiation region, and other irradiation forms.

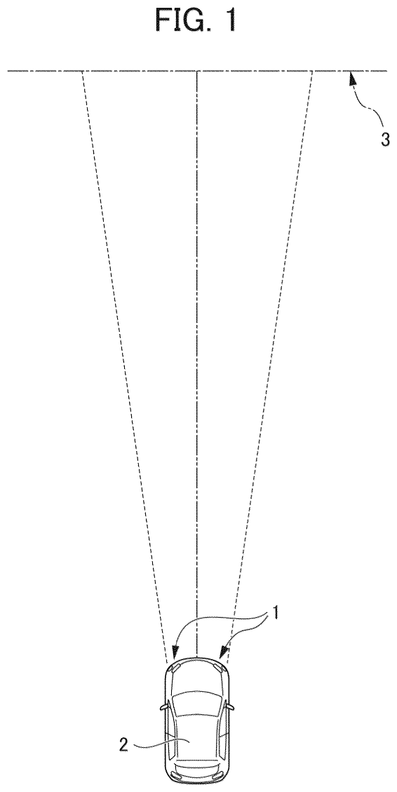

FIG. 1 is a schematic view showing an aspect of irradiation of illumination light by a vehicle lighting device 1 according to an embodiment of the present invention. Ahead of the front of the vehicle lighting device 1 provided to a vehicle 2, for example, the distribution of irradiation light from the vehicle lighting device 1 is evaluated by an irradiation pattern formed on a test screen 3, which is a predetermined virtual vertical plane established 25 m ahead.

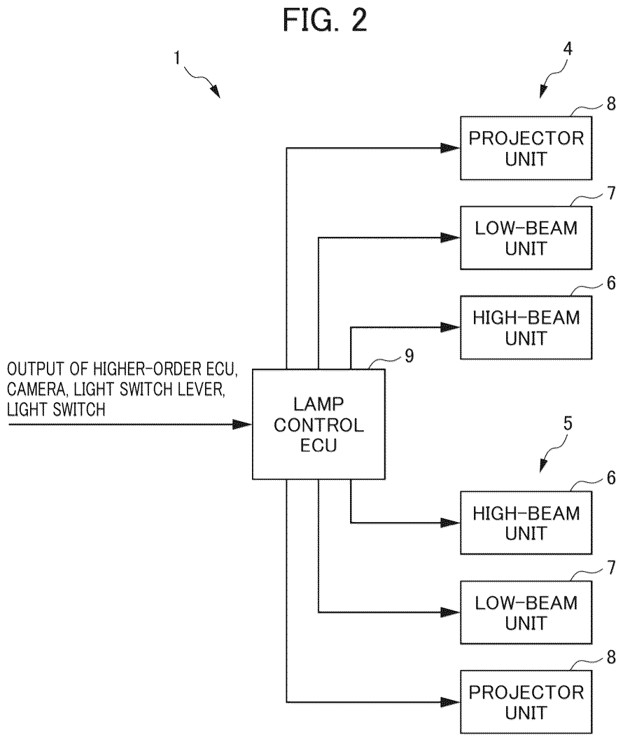

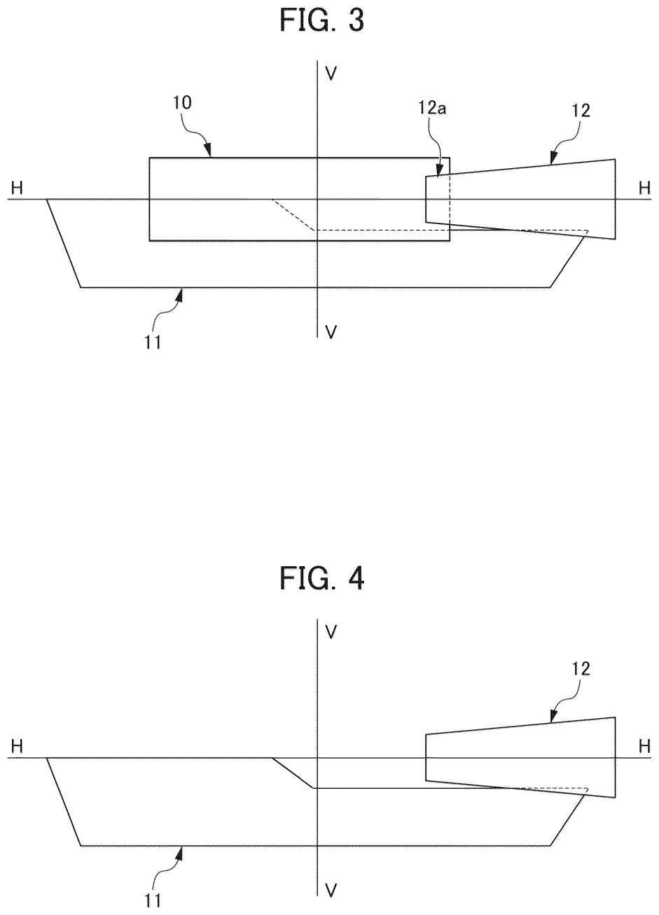

FIG. 2 is a block diagram of the vehicle lighting device 1, and FIG. 3 is a view showing the irradiation region of each lamp of the vehicle lighting device 1. At each of a left-side headlight unit 4 and right-side headlight unit 5 which are lamps, a high-beam unit 6, low-beam unit 7 and projector unit 8 are arranged in order from the inner side to the outer side in the vehicle-width direction of the vehicle 2. In each of the left-side headlight unit 4 and right-side headlight unit 5, the high-beam unit 6, low-beam unit 7 and projector unit 8 operate under the control of a lamp control ECU 9.

The high-beam unit 6 includes a light emitting element which is the light source, a light shield which defines the irradiation region and a lens. The light emitting element generates light by electric power being supplied from a power source (not shown), in response to a control signal from the lamp control ECU 9. The light from the light emitting element is reflected by the reflector. The reflected light from the reflector is irradiated from the lens toward a high-beam irradiation region 10 defined by the light shield.

The low-beam unit 7 includes a light emitting element which is a light source, a reflector, a light shield which defines the irradiation region, and a lens. The light emitting element generates light by electric power being supplied from a power source (not shown), in response to a control signal from the lamp control ECU 9. The light from the light emitting element is reflected by the reflector. The reflected light from the reflector is irradiated from the lens towards the low-beam irradiation region 11 defined by the light shield.

The projector unit 8 includes a light emitting element which is a light source, a spatial light modulator and a lens. As the spatial light modulator, for example, it is possible to utilize one of a form which reflects light, while independently modulating the several reflecting elements as in a DMD (Digital Micromirror Device). In this case, the projector unit 8 assumes a configuration of a DLP (Digital Light Processing: registered trademark) system using DMD, and can irradiate light in various predetermined irradiation patterns from the lens to the front of the vehicle 2 and its surroundings.

The irradiation pattern can also assume not only still image patterns of various shapes, but also the form of a video pattern. The light emitting element generates light by driving electric power being supplied from a power source (not shown) in response to a control signal from the lamp control ECU 9. The light from this light emitting element is spatially modulated by the spatial light modulator driven according to the control signal from the lamp control ECU 9, and light is irradiated from the lens of the projector unit 8 in various predetermined irradiation patterns in front of the vehicle 2 and the surroundings thereof. In other words, the projector unit 8 configures a pattern irradiation part which irradiates the irradiation light in a forward irradiation region ahead in the traveling path of the vehicle 2 in the irradiation pattern in which a bright region and dark region are alternately repeated.

By referencing FIG. 3, the irradiation region by the high-beam unit 6, low-beam unit 7 and projector unit 8 will be explained in the case of irradiating light on the test screen 3 from the vehicle lighting device 1 of FIG. 1. Herein, regarding the irradiation region by the projector unit 8, the irradiation region by the projector unit 8 of the right-side headlight unit 5 is shown.

The irradiation region by the projector unit 8 of the left-side headlight unit 4 is symmetrical with the irradiation region by the projector unit 8 of the right-side headlight unit 5 with the line V-V as the axis of symmetry.

The configuration and operation of the projector unit 8 of the left-side headlight unit 4 are similar to the projector unit 8 of the right-side headlight unit 5. For this reason, the configuration and operation of the projector unit 8 of the left-side headlight unit 4 invoke the explanations for the projector unit 8 of the right-side headlight unit 5.

The low-beam irradiation region 11 by the low-beam unit 7 has an oncoming-lane side cutoff line extending in parallel to a line H-H (horizontal line) more to the right side than the line V-V (vertical line) at the center in the left/right direction on the test screen 3. In addition, it has an own-lane side cutoff line extending along the line H-H at a higher position than the oncoming-lane side cutoff line. Both the oncoming-lane side cutoff line and own-lane side cutoff line are linked by an oblique cutoff line which slopes relative to the line H-H. The low-beam irradiation region 11 is a lower irradiation region on the front lower side of the vehicle 2.

The high-beam irradiation region 10 by the high-beam unit 6 forms a rectangle having a long side parallel to the line H-H and a short side parallel to the line V-V, and an intersection of their diagonals occupy a position substantially matching the intersection of the line H-H and line V-V. The high-beam irradiation region 10 overlaps the low-beam irradiation region 11 in a lower partial region including a portion more to the line V-V of each of the oncoming lane side cutoff line and the own-lane side cutoff line. The high-beam irradiation region 10 is an upper irradiation region more upwards than the low-beam irradiation region 11, which is the lower irradiation region, and more to the central side in the vehicle-width direction of the vehicle 2.

In the right-side pattern irradiation region 12, which is the irradiation region by the projector unit 8 of the right-side headlight unit 5, the irradiation pattern variously changes such as the contour shape of the region and the form of the irradiation pattern within this region, according to the mode switching signal from the lamp control ECU 9. However, the right-side pattern irradiation region 12 is a lateral irradiation region on the travel path side of the vehicle 2, even in the case of assuming the any form of irradiation pattern.

Concerning the ability of the projector unit 8, the right-side pattern irradiation region 12 can assume a wide form including an overlap region 12a which overlaps with the high-beam irradiation region 10. In the case of assuming this form, the right-side pattern irradiation region 12 makes a trapezoidal shape in a landscape orientation in which the height direction is parallel to the line H-H, and the upper base and lower base are parallel to the line V-V. This trapezoid is longer at the lower base which is relatively far from the line V-V than the upper base which is relatively close to the line V-V. In other words, the right-side pattern irradiation region 12 makes a shape in which the dimension along the line V-V towards the outer side in the vehicle width direction of the vehicle 2 widens.

The lamp control ECU 9 switches the operation mode of the vehicle lighting device 1, based on the output from a higher-order ECU, camera, light switch, light switch lever, etc., which are not shown, equipped to the vehicle 2. In other words, the lamp control ECU 9 supplies a control signal to the high-beam unit 6, low-beam unit 7 and projector unit 8, and switches the operation mode of each of these units.

FIG. 4 is a view showing the irradiation region of irradiation light by the vehicle lighting device 1, in the case of the operation mode according to the lamp control ECU 9 being set to the low-beam mode. At night, when the light switch is in the position of “auto”, and the light switch lever is at a position other than low beam, the vehicle lighting device 1 is often in the state of high-beam mode. In this state, when the camera detects oncoming vehicles, ahead vehicles or a certain number of street lights, the operation mode of the vehicle lighting device 1 switches to the low-beam mode by the lamp control ECU 9. During low-beam mode, the high-beam unit 6 is turned off under the control by the lamp control ECU 9, the low-beam unit 7 irradiates the low-beam irradiation region 11, and the projector unit 8 irradiates the right-side pattern irradiation region 12.

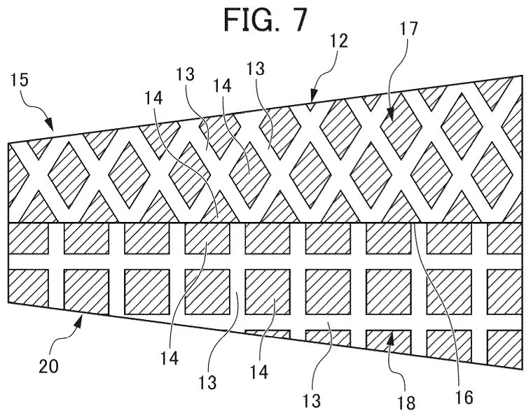

During low-beam mode, the right-side pattern irradiation region 12 occupies a wide region of the trapezoidal shape in landscape orientation including the aforementioned overlap region 12a. In this wide region, the pattern irradiation light is irradiated in a first irradiation pattern 15 in which the bright regions 13 and dark regions 14 are alternately repeated as shown in FIG. 7 from the projector unit 8. The first irradiation pattern 15 in FIG. 7 is particularly a rhombus lattice pattern by the bright regions 13 of mesh pattern of rhombus lattice and the dark regions 14 surrounded by these bright regions 13.

By the irradiated light of the first irradiation pattern from the projector unit 8 of the right-side headlight unit 5, the presence of a pedestrian on the roadside is easily recognized from the driver by the visual characteristic of humans. Even under adverse conditions such as night and rainy weather, it is possible to improve the overlooking of pedestrians by the driver.

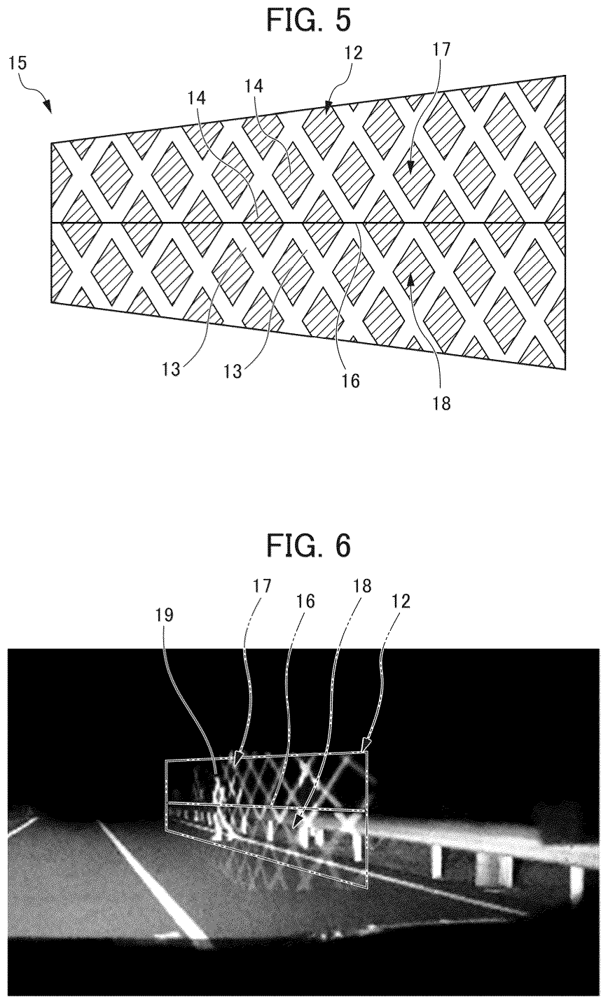

With the vehicle lighting device 1 of the present embodiment, the right-side pattern irradiation region 12 can be divided into an upper pattern irradiation region 17 on the upper side of a boundary line 16 traversing this region along the line H-H, and a lower pattern irradiation region 18 on a lower side of the boundary line 16. This section is demarcated by the projector unit 8 independently irradiating the upper pattern irradiation region 17 and lower pattern irradiation region 18 under the control of the lamp control ECU 9. In the example shown in FIG. 5, irradiated light is irradiated in the first irradiation pattern 15, which is the shape of the rhombus lattice pattern in the upper pattern irradiation region 17 and lower pattern irradiation region 18. However, the upper pattern irradiation region 17 is irradiated in a mode of relatively low irradiation intensity, and the lower pattern irradiation region 18 is irradiated in a mode of relatively high irradiation intensity.

FIG. 6 is a view showing an aspect of irradiating the driver field of view at night from the front windshield of the vehicle 2 by the vehicle lighting device 1 of the present embodiment. In FIG. 6, the same symbols are attached to corresponding parts with FIG. 5. In the driver field of view in FIG. 6, the rhombus lattice pattern which is the first irradiation pattern 15 in FIG. 5 is irradiated on the upper pattern irradiation region 17 and lower pattern irradiation region 18 of the right-side pattern irradiation region 12, towards the right front of the roadside.

A pedestrian 19 is visually recognized on the right front of the roadside. For the pedestrian 19, the rhombus lattice pattern is irradiated, and the presence thereof is remarkably recognized by the visual characteristics of humans. In this case, the dynamic change of bright/dark of lattice form corresponding to the pattern irradiation within the contour of the pedestrian 19 is more prominently recognized from the driver side, than the contour of the pedestrian 19 is visually recognized, whereby the concern of overlooking the pedestrian 19 is effectively decreased.

Furthermore, since the upper pattern irradiation region 17 is irradiated in a mode of relatively low irradiation intensity, the dazzling on the pedestrian 19 side is reduced, while since the lower pattern irradiation region 18 is irradiated in a mode of relatively high irradiation intensity, the legs of the pedestrian 19 are remarkably recognized from the driver side.

FIG. 7 is a view showing a case of configuring the projector unit 8 to irradiate the upper pattern irradiation region 17 and lower pattern irradiation region 18 in different irradiation patterns under the control of the lamp control ECU 9. The projector unit 8 irradiates the irradiation light in the first irradiation pattern 15, which is the aforementioned first mode on the upper pattern irradiation region 17 of the right-side pattern irradiation region 12. At the same time, the projector unit 8 irradiates the irradiation light in the second mode differing from the first mode on the lower pattern irradiation region 18. The second irradiation pattern 20 which is the second mode is a lattice-like pattern in which a vertical and horizontal lattice bright regions 13 are superimposed on the dark regions 14 which are the background.

Even in the case of assuming the irradiation pattern shape of FIG. 7, under the control of the lamp control ECU 9, the upper pattern irradiation region 17 is irradiated in a mode of relative low irradiation intensity, and the lower pattern irradiation region 18 is irradiated in a mode of relatively high irradiation intensity. Dazzling on the side of the pedestrian 19 is reduced, while from the driver side, the upper body of the pedestrian 19 irradiated by the rhombus lattice pattern is remarkably recognized by the visual characteristic of humans. In addition, from the driver side, the legs of the pedestrian 19 irradiated by the lattice-like pattern of high irradiation intensity is remarkably recognized. For this reason, the concern of the driver overlooking the pedestrian 19 is effectively reduced.

According to the vehicle lighting device 1 of the present embodiment, the following effects are exerted.

(1) The vehicle lighting device 1 includes the low-beam unit 7 that illuminates the low-beam irradiation region 11; a high-beam unit 6 that illuminates the high-beam irradiation region 10; and the projector unit 8 as a pattern irradiation part that illuminates the right-side pattern irradiation region 12, which is a lateral irradiation region on the travel path side of the vehicle 2. The projector unit 8 irradiates the irradiation light on the right-side pattern irradiation region 12 in a form of the first irradiation pattern 15 in which the bright regions 13 and dark regions 14 are alternately repeated. In this case, the projector unit 8 irradiates the irradiation light in the first mode of relatively low irradiation intensity on the upper pattern irradiation region 17 on the upper side of the right-side pattern irradiation region 12, and irradiates the irradiation light in the second mode of relatively high irradiation intensity on the lower pattern irradiation region 18 on the lower side of the right-side pattern irradiation region 12. Since the upper pattern irradiation region 17 is irradiated in the mode of relatively low irradiation intensity, the dazzling on the side of the pedestrian 19 is reduced. On the other hand, since the lower pattern irradiation region 18 is irradiated in a mode of relatively high irradiation intensity, the legs of the pedestrian 19 are remarkably recognized from the side of the driver. Even under adverse conditions such as at night and rainy weather, it is possible to improve overlooking of a pedestrian 19 by the driver.

(2) With the vehicle lighting device 1, the second mode which is an irradiation mode of irradiation light on the lower pattern irradiation region 18 is a mode of higher irradiation intensity than the first mode, which is an irradiation mode of irradiation light on the upper pattern irradiation region 17. It is thereby possible to irradiate the legs of the pedestrian 19 on the roadside with high illumination by the irradiation light on the lower pattern irradiation region 18, and remarkably recognize the motion of the legs of the pedestrian 19 from the driver side. On the other hand, since the irradiation intensity of irradiation light to the upper pattern irradiation region 17 is relatively low, it is possible to avoid dazzling on the side of the pedestrian.

(3) With the vehicle lighting device 1, the first mode which is an irradiation mode of irradiation light to the lower pattern irradiation region 18 is a mode irradiating the irradiation light in the irradiation pattern (first irradiation pattern 15) of the rhombus lattice pattern by the bright regions 13 of mesh design of a rhombus lattice, and the dark regions 14 surrounded by these bright regions. In addition, the second mode which is the irradiation mode of irradiation light on the lower pattern irradiation region 18 is a mode irradiating the irradiation light in a lattice-like irradiation pattern (second irradiation pattern 20) in which the vertical and horizontal lattice-like bright regions are superimposed on the dark regions serving as the background. When the light of the first irradiation pattern 15 is irradiated on the pedestrian, the driver can easily recognize the presence of the pedestrian 19 by the visual characteristic of humans.

Although an embodiment of the present invention has been explained above, the present invention is not limited thereto. The configurations of detailed parts may be modified as appropriate within the scope of the gist of the present invention. In the aforementioned embodiment, a configuration managing the operation of the projector unit 8 by the lamp control ECU 9 was adopted. Alternatively, for example, it can adopt a configuration which manages operation of the projector unit 8 by a higher-order ECU that constantly monitors the travel situation of one's own vehicle, and switches the irradiation mode of the irradiation light. In addition, in the case of including a pedestrian detection device such as an imaging device that photographs ahead of the vehicle, and detects the presence of a pedestrian in a forward irradiation region, the pattern irradiation part may irradiate irradiation light in a predetermined first mode in an upper pattern irradiation region which is on an upper side of a lateral irradiation region, and may irradiate irradiation light in a second mode different from the first mode in a lower pattern irradiation region which is on a lower side of the lateral irradiation region. Furthermore, it may detect an upper body portion and lower body portion of pedestrians by a pedestrian detection device, the pattern irradiation part may irradiate the irradiation light in a predetermined first mode on the upper body portion of the pedestrian as the upper pattern irradiation region which is the upper side of the lateral irradiation region, and may irradiate the irradiation light in a second mode different from the first mode on the lower body portion of the pedestrian as the lower pattern irradiation region which is the lower side of the lateral irradiation region.

### EXPLANATION OF REFERENCE NUMERALS

1 vehicle lighting device
2 vehicle
3 test screen
4 left-side headlight unit
5 right-side headlight unit
6 high-beam unit
7 low-beam unit
8 projector unit (variable pattern irradiation part)
9 lamp control ECU
10 high-beam irradiation region (upper irradiation region)
11 low-beam irradiation region (lower irradiation region)
12 right-side pattern irradiation region (side irradiation region)
12a overlap region
13 bright region
14 dark region
15 first irradiation pattern
16 boundary line
17 upper pattern irradiation region
18 lower pattern irradiation region
19 pedestrian
20 second irradiation pattern

What is claimed is:

1. A vehicle lighting device comprising:
a low-beam irradiation part which illuminates a lower irradiation region on a forward lower side of a vehicle;
a high-beam irradiation part which illuminates an upper irradiation region on an upper side and more to a central side in a vehicle-width direction than the lower irradiation region; and
a pattern irradiation part which irradiates irradiation light on a lateral irradiation region that is a travel path side of the vehicle in an irradiation pattern in which a bright region and a dark region are alternately repeated,
wherein the pattern irradiation part irradiates irradiation light in a predetermined first mode on an upper pattern irradiation region that is an upper side of the lateral irradiation region, and irradiates irradiation light in a second mode different from the first mode in a lower pattern irradiation region that is a lower side of the lateral irradiation region.

2. The vehicle lighting device according to claim 1, wherein the second mode is a mode of higher irradiation intensity than the first mode.

3. The vehicle lighting device according to claim 1, wherein the first mode is a mode which irradiates irradiation light in an irradiation pattern which is a rhombus lattice pattern by bright regions of a mesh design of rhombus lattice, and dark regions surrounded by the bright regions, and the second mode is a mode which irradiates irradiation light in a lattice-like irradiation pattern in which vertical and horizontal lattice-like bright regions are superimposed on dark regions serving as a background.

4. The vehicle lighting device according to claim 1, wherein the first mode is a mode which irradiates irradiation light in an irradiation pattern which is a rhombus lattice pattern by bright regions of a mesh design of rhombus lattice, and dark regions surrounded by the bright regions, and the second mode is a mode of higher irradiation intensity than the first mode, and which irradiates irradiation light in a lattice-like irradiation pattern in which vertical and horizontal lattice-like bright regions are superimposed on dark regions serving as a background.
